(19) United States
(12) Patent Application Publication
(10) Pub. No.: US 2006/0259670 A1
(43) Pub. Date: Nov. 16, 2006

(54) Bus coupling without plug connections for automation devices

(76) Inventors: Martin Meinke, Amberg (DE); Klaus Windsheimer, Spalt (DE)

Correspondence Address: HARNESS, DICKEY & PIERCE, P.L.C., P.O.BOX 8910, RESTON, VA, 20195, US

(21) Appl. No.: 10/567,469

(22) PCT Filed: Jul. 14, 2004
(86) PCT No.: PCT/EP04/07796

§ 371 Date: Feb. 7, 2006

(30) Foreign Application Priority Data
Aug. 8, 2003 (DE) 103 36 572.9

(51) Int. Cl. G06F 13/00

(52) U.S. Cl. 710/100

(57) ABSTRACT

An aim of an embodiment of the invention is to couple load feeders to back plane buses without the danger of the junctions being damaged. For this purpose, a back plane bus module is provided with a coupling element, especially a BUS-ASIC with which a point-to-point communication link to the automation device or the load feeder can be established. An optical interface is connected to the BUS-ASIC and is used to establish communication to a load feeder by an optical coupling. The optical coupling can for example prevent plug connections from being damaged when the load feeder is coupled thereto and at the same time provide for galvanic separation.

This application is the national phase under 35 U.S.C. § 371 of PCT International Application No. PCT/EP2004/007796 which has an International filing date of Jul. 14, 2004, which designated the United States of America and which claims priority on German Patent Application number DE 103 36 572.9 filed Aug. 8, 2003, the entire contents of which are hereby incorporated herein by reference.

### FIELD

The present invention generally relates to a bus module for connecting an automation unit to a backplane bus which can be used to transport data and/or power, for example. The bus module may include at least one bus connecting device for connection to the backplane bus and at least one unit connecting device—including a serial optical interface—for connection to the automation unit. In addition, the present invention generally relates to a load feeder apparatus which is intended to be coupled to a backplane bus and has an interface for communicating with a backplane bus module.

### BACKGROUND

Backplane buses are used to couple decentralized peripherals to data buses such as a Profibus, ASI bus or CAN bus. The demands imposed on backplane buses are accordingly less than these on the latter buses.

A backplane bus module as illustrated in FIG. 1 is usually used to connect an automation unit or actuator to a backplane bus. Connecting lines AL1 are tapped off the plurality of bus lines BL1 of the backplane bus module RM1. The connecting lines each open into plug connection contacts (not illustrated). A bus connection or a load feeder VA1 is inserted into these plug connection contacts. Eight plug connections are required in the present example. Since the voltages and currents at the interface are small, correspondingly high demands must be imposed on the contacts. Only gold-plated contacts are therefore generally suitable.

Since a load feeder VA1 is usually relatively large and heavy, it should be possible to pivot the load feeder VA1 into the backplane bus module RM1 for more convenient fitting. This operation of pivoting the load feeder may result in damage to the contacts if handled incorrectly, especially if the contacts are arranged, for example, in the small 2.54 mm grid. The contacts therefore need to be placed as far away from the pivoting shaft as possible so that the pins or sockets of the plug connections are not bent.

In the load feeder, the data received from the backplane bus module RM1 and the power provided by the bus need to be passed to a microcontroller μC1. To this end, DC isolation is required between the bus and the power supply (24 V). This isolation is usually implemented using five optocouplers OK which are driven by a bus ASIC BA1. The bus ASIC thus provides a serial interface having five lines. The optical coupling can be used to ensure isolation resistance for, for example, 500 V or 6 kV. The microcontroller is used to implement technology and control functions, for example drivers for contactor coils, a thermal motor model, diagnoses, soft starters and the like.

### SUMMARY

An object of at least one embodiment of the present invention is thus to propose a backplane bus coupling in which damage to the contacts can be avoided when connecting a load feeder.

According to at least one embodiment of the invention, an object may be achieved by a bus module for connecting an automation unit to a backplane bus which can be used to transport data and/or power. At least one embodiment of the bus module includes at least one bus connecting device for connection to the backplane bus and at least one unit connecting device—including a serial optical interface—for connection to the automation unit, with the unit connecting device having a coupling element which can be used to set up a point-to-point communication link to the automation unit.

In addition, at least one embodiment of the invention provides a corresponding load feeder apparatus which is intended to be coupled to a backplane bus and has an interface for communicating with a backplane bus module, with the interface being a serial optical interface.

The optical interface permits advantageously no need for a mechanical plug connection. Damage to the contacts can consequently also be avoided.

The optical interface results in DC isolation between a load feeder that is to be connected and the backplane bus module at the point at which they are connected. There is therefore no need for DC isolation within the load feeder.

The optical interface also increases the flexibility in terms of connecting load feeders. A plurality of load feeders may thus be supplied by one bus module, if necessary.

Since the optical interface always constitutes a defined electrical termination, undefined states do not result in the bus system if a load feeder is not connected. In particular, a load feeder which has not been plugged in does not result in the bus being interrupted.

The coupling element for setting up point-to-point communication preferably includes a bus ASIC. This makes it possible to implement matched communication on a simple level in a very effective manner.

The unit connecting device of the backplane bus module may also have a microcontroller which is connected to the coupling element and controls the serial optical interface. Optical communication can thus be managed flexibly.

The serial optical interface may include a UART interface. This standardized interface opens up a wide field of application.

In one alternative embodiment, the UART interface may be integrated directly in the coupling element, in particular the bus ASIC, so that no separate microcontroller is required.

The optical interface may also enable half-duplex or full-duplex operation. Depending on the individual circumstances, it is thus possible to set up a simpler or more complex connection to a load feeder.

### BRIEF DESCRIPTION OF THE DRAWINGS

Example embodiments of the present invention are explained in more detail with reference to detailed description and to the attached drawings, in which:

FIG. 1 shows a block diagram of a backplane bus coupling according to the prior art, and

FIG. 2 shows a block diagram of a backplane bus coupling according to an embodiment of the present invention.

The example embodiment described in more detail below represents one example embodiment of the present invention.

### DETAILED DESCRIPTION OF THE EXAMPLE EMBODIMENTS

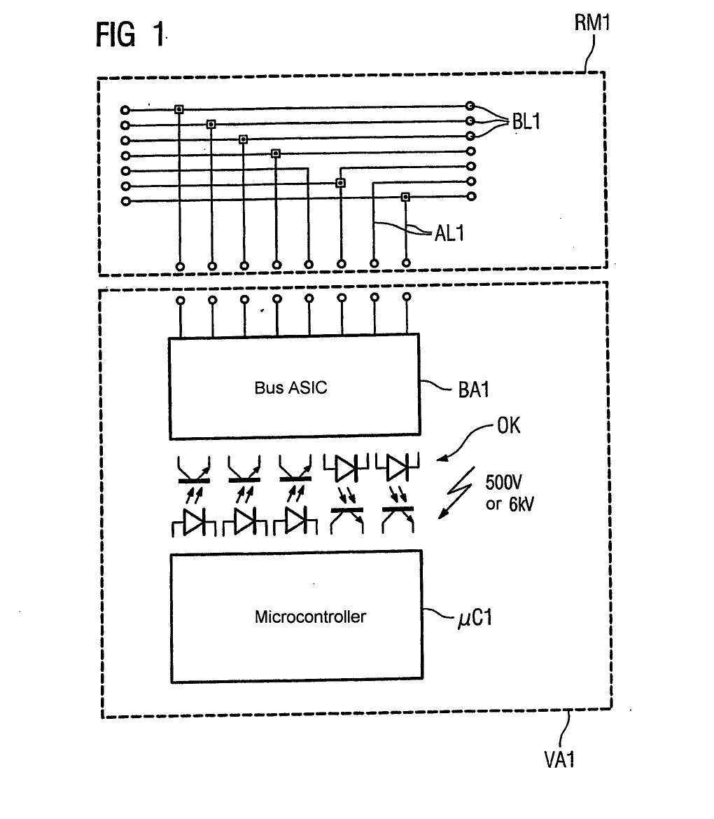

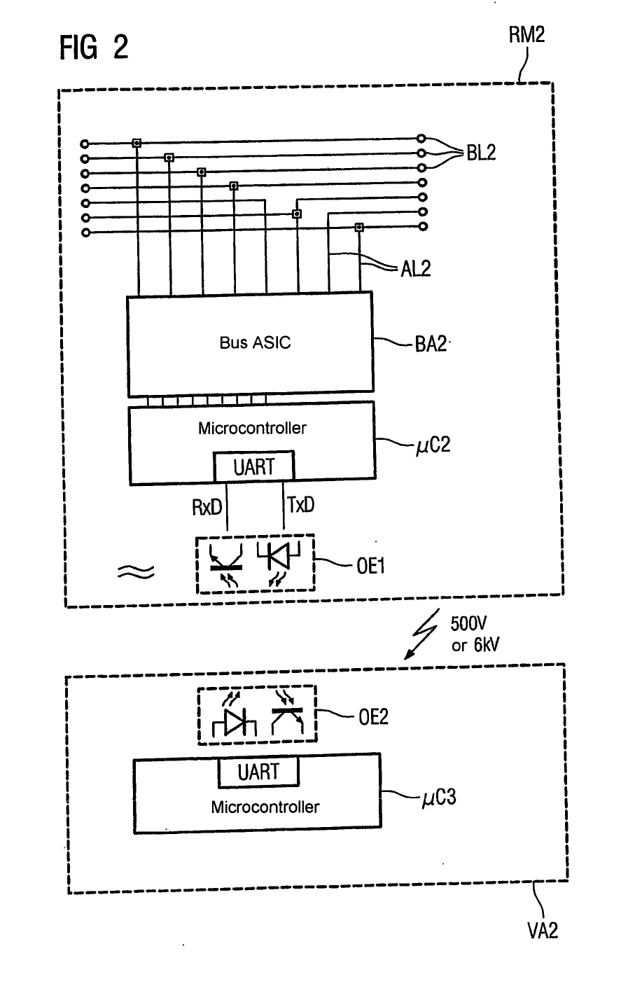

The backplane bus module RM2 according to an embodiment of the invention as shown in FIG. 2 has increased functionality compared to the backplane bus module RM1 shown in FIG. 1. A bus ASIC BA2 in the backplane bus module RM2 is directly connected to the connecting lines AL2 which represent branches from the bus lines BL2. The bus ASIC BA2 constitutes a simple communication link (point-to-point) to an optical interface which is connected to the bus ASIC and is likewise accommodated in the backplane bus module RM2.

The optical interface includes a microcontroller μC2 which itself operates an optics unit OE1 via an integrated UART interface. The optics unit OE1 is indicated symbolically by a transmitting diode and a light-sensitive receiving transistor. By way of example, transmission data TxD may thus be emitted using an infrared transmitting diode and received data RxD may be received using an IR light-sensitive transistor.

A load feeder module VA2 is placed at a suitable distance from the backplane bus module RM2. This distance must be selected in such a way that optical communication can take place in an unimpeded manner and, on the other hand, the requisite electrical isolation from voltages of 500 V or 6 kV is ensured.

The load feeder VA2 itself has an optics unit OE2 which is likewise symbolized in FIG. 2 by a light-emitting diode and a light-sensitive transistor. The optics unit OE2 optically is connected to the optics unit OE1 of the backplane bus module RM2. The DC isolation achieved thereby makes it possible, for example, for the load feeder VA2 to be reliably operated at a potential of 24 V.

The optics unit OE2 is driven by a further microcontroller μC3, likewise via a standardized UART interface. In this case too, the microcontroller μC3 undertakes technology functions such as driving contactor coils and carrying out diagnostic and soft starter functions.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A bus module for connecting an automation unit to a backplane bus usable to transport at least one of data and power, the bus module comprising:
at least one bus connecting device for connection to the backplane bus; and
at least one unit connecting device including a serial optical interface for connection to the automation unit, the unit connecting device including a coupling element, usable to set up a point-to-point communication link to the automation unit.

2. The bus module as claimed in claim 1, wherein the coupling element includes a bus ASIC.

3. The bus module as claimed in claim 1, wherein the unit connecting device includes a microcontroller which is connected to the coupling element and drives the serial optical interface.

4. The bus module as claimed in claim 1, wherein the serial optical interface includes a UART interface.

5. The bus module as claimed in claim 4, wherein the UART interface is integrated in the coupling element.

6. The bus module as claimed in claim 1, wherein the optical interface enables at least one of half-duplex and full-duplex operation.

7. A load feeder apparatus for coupling to a backplane bus, comprising:
an interface to communicate with a bus module, the interface being a serial optical interface.

8. The load feeder apparatus as claimed in claim 7, further comprising a microcontroller to controls the serial optical interface.

9. The load feeder apparatus as claimed in claim 7, wherein the serial optical interface includes a UART interface.

10. The load feeder apparatus as claimed in claim 7, wherein the optical interface enables at least one of half-duplex and full-duplex operation.

11. The bus module as claimed in claim 2, wherein the unit connecting device includes a microcontroller connected to the coupling element and drives the serial optical interface.

12. The bus module as claimed in claim 2, wherein the serial optical interface includes a UART interface.

13. The load feeder apparatus as claimed in claim 8, wherein the serial optical interface includes a UART interface.

14. The load feeder apparatus as claimed in claim 8, wherein the optical interface enables at least one of half-duplex and full-duplex operation.

15. The load feeder apparatus as claimed in claim 9, wherein the optical interface enables at least one of half-duplex and full-duplex operation.

16. A load feeder apparatus for coupling to a backplane bus, comprising:
interface means for communicating with a bus module, the interface means including a serial optical interface; and
control means for controlling the serial optical interface.

17. The load feeder apparatus as claimed in claim 16, wherein the serial optical interface includes a UART interface.

18. The load feeder apparatus as claimed in claim 16, wherein the optical interface enables at least one of half-duplex and full-duplex operation.
